(19) United States
(12) Patent Application Publication
(10) Pub. No.: US 2025/0033964 A1
(43) Pub. Date: Jan. 30, 2025

(54) METHODS AND APPARATUS FOR PRODUCTION OF HYDROGEN

(71) Applicant: Research Triangle Institute, Research Triangle Park, NC (US)

(72) Inventors: Shaojun James Zhou, Research Triangle Park, NC (US); Raghubir P. Gupta, Research Triangle Park, NC (US); John Reeves Carpenter, III, Research Triangle Park, NC (US); Brian S. Turk, Research Triangle Park, NC (US)

(21) Appl. No.: 18/225,191

(22) Filed: Jul. 24, 2023

(51) Int. Cl. C01B 3/56; C01B 3/12; C01B 3/50

(52) U.S. Cl. CPC C01B 3/56; C01B 3/12; C01B 3/501; C01B 2203/0283; C01B 2203/041; C01B 2203/0425; C01B 2203/146; C01B 2203/148

(57) ABSTRACT

Synthesis gas containing nitrogen as the majority component is processed to increase the hydrogen to carbon dioxide ratio. Nitrogen, carbon dioxide, and other contaminants are subsequently removed by a purification unit to produce a purified hydrogen gas stream. A recycle stream within the purification unit helps achieve a hydrogen purity greater than 99.9 percent, and hydrogen recovery greater than 99 percent.

### RELATED APPLICATIONS

This application is a divisional of U.S. application Ser. No. 16/652,318, filed Mar. 30, 2020, which was a § 371 U.S. National Stage of International Application No. PCT/US18/52394, filed Sep. 24, 2018 having Atty. Docket No. 121-82-PCT, which claims the benefit of U.S. Provisional Patent Application Ser. No. 62/565,873, filed Sep. 29, 2017, titled “METHODS AND APPARATUS FOR PRODUCTION OF HYDROGEN” the content of which are hereby incorporated by reference in their entireties

### TECHNICAL FIELD

The present invention generally relates to the treating or purifying of a gas stream, particularly removing nitrogen and carbon dioxide from a gas stream to produce hydrogen.

### BACKGROUND

Hydrogen (H₂) is one of the most important industrial gases, used widely in petroleum refineries and petrochemical plants. Hydrogen is also used in semi-conductor industry, steel production, food industry, power industry and the like. Lately, hydrogen has become a fuel of choice for fuel cell-operated systems like automobiles, forklifts, etc. Hydrogen is typically produced at large scale using high-temperature reforming or partial oxidation of methane and/or hydrocarbons or through gasification of carbonaceous feedstocks. Production of smaller volumes of hydrogen presents significant cost and reliability challenges and is not widely practiced in the industry, except through electrolysis of water.

With recent market penetration of fuel cell-based vehicles (including passenger cars, buses, trucks) and equipment (e.g., forklifts used in warehouses), on-site production of hydrogen in 200-300 kg/day quantities is a key enabling process technology for continued and accelerated growth of the overall fuel cell market and the fuel cell-based vehicular market in particular. There are no technically viable or cost-effective options for production of hydrogen on-site at this scale. Electrolysis of water using electricity in an electrochemical cell is expensive and suffers from reliability issues. Steam methane reformers or coal gasifiers cannot be scaled down in a cost-effective manner to produce these small quantities of hydrogen.

High-temperature reforming of methane and hydrocarbons produces an intermediate gas stream which is referred to as synthesis gas or “syngas”. Syngas can also be produced from partial oxidation and gasification of organic feedstocks (coal, petroleum coke, biomass, oil, hydrocarbons). When oxygen is used as the oxidizing agent in these processes, the syngas consists of primarily carbon monoxide (CO), H₂, carbon dioxide (CO₂), and steam. When air is used as the oxidizing agent, the large fraction of nitrogen (N₂) in air becomes the major component in the syngas with CO, H₂, CO₂ and steam representing minor components. For many processes, it is desirable to separate a high purity H₂ gas from the syngas. For syngas production based on the utilization of air rather than oxygen as an oxidizing agent, this increases the complexity of the H₂ separation process as the nitrogen, which is the majority component must also be removed. For example, polymer electrolyte membrane fuel cells for automotive applications require 99.97 percent or greater purity H₂ gas because contaminants within the H₂ gas can interfere with or poison electrocatalysts in the fuel cell. High purity H₂ may also be used in propellants, semiconductor manufacturing, analytical instrumentation, and as the starting material in the production of a variety of chemicals.

Conventional processes to purify syngas generated using oxygen as the oxidizing agent to produce high-purity hydrogen require a series of gas processing and cleanup steps, including separate removal of CO₂ using solvent scrubbing, followed by pressure-swing adsorption to achieve the highest levels of H₂ purity. The tail gas produced by pressure swing adsorption is typically used as a fuel gas for heating value, resulting in significant loss of H₂, rendering these processes to be inefficient and costly. For syngas generated using air as the oxidizing agent, the high nitrogen concentration in the syngas can only be separated by pressure-swing adsorption, but the resulting tail gas contains a large amount of nitrogen, which reduces its fuel value and increases H₂ losses. Because of these issues, syngas generated with air as the oxidant is not used for commercial hydrogen production as it is not cost competitive.

### SUMMARY

To address the foregoing problems, in whole or in part, and/or other problems that may have been observed by persons skilled in the art, the present disclosure provides methods, processes, systems, apparatus, instruments, and/or devices, as described by way of example in implementations set forth below.

According to one embodiment, a method for producing a purified hydrogen gas stream comprises flowing a syngas produced from partial oxidation of hydrocarbons into a processing unit to produce an enhanced gas. The syngas typically contains N₂ (as the majority component), H₂, CO, CO₂, and H₂O, and may contain trace amounts of H₂S, COS, CS₂, NH₃, HCN, oxygen and inert gases like Ar. The syngas fed to the processing unit may have an initial H₂ to CO molar ratio, and the enhanced gas may have a second H₂ to CO ratio greater than the initial H₂ to CO ratio. The enhanced gas may subsequently flow into a purification unit. The purification unit may produce a purified H₂ gas stream and a tail gas. The purification unit may comprise a bulk separation unit to perform the bulk separation of the impurities into an impurity-rich byproduct and an enriched H₂ product and a second separation unit for producing a high purity H₂ product and tail gas with the remaining impurities. At least a portion of the tail gas may be recycled to a point upstream of the bulk separation unit.

According to another embodiment, a method for producing a purified hydrogen gas stream comprises flowing a feed gas containing N₂ as the majority component, H₂, and CO into a processing unit to produce an enhanced gas. The feed gas may have an initial H₂ to CO ratio, and the enhanced gas may have a second H₂ to CO ratio greater than the initial H₂ to CO ratio. The enhanced gas may flow into contact with a membrane in a membrane unit to produce a permeate stream and a retentate stream. The membrane may have a H₂-selective composition. A concentration of H₂ in the permeate stream may be greater than a concentration of H₂ in the enhanced gas, and the retentate stream may comprise N₂ and other impurities that are removed from the enhanced gas. The permeate stream may flow into contact with an adsorbent material in one or more adsorption columns to produce a purified H₂ gas stream. The adsorbent material in one or more of the adsorption columns may be regenerated to produce a tail gas. At least a portion of the tail gas may be recycled to mix into the enhanced gas stream at a point upstream of the membrane unit.

According to another embodiment, a method for producing purified hydrogen gas stream comprises flowing a feed gas that is typically produced from gasification of coal and/or petroleum coke and which may contain appreciable quantities of H₂S and COS in addition to N₂, CO, H₂, CO₂, and H₂O into a desulfurization unit as disclosed in U.S. Pat. No. 6,951,635 producing a very-low sulfur containing syngas, which is subsequently fed into a processing unit to produce an enhanced gas. The feed gas may have an initial H₂ to CO ratio, and the enhanced gas may have a second H₂ to CO ratio greater than the initial H₂ to CO ratio. The enhanced gas may flow into contact with a membrane in a membrane unit to produce a permeate stream and a retentate stream. The membrane may have a H₂-selective composition. A concentration of H₂ in the permeate stream may be greater than a concentration of H₂ in the enhanced gas, and the retentate stream may comprise N₂ and other impurities that are removed from the enhanced gas. The permeate stream may flow into contact with an adsorbent material in one or more adsorption columns to produce a purified H₂ gas stream. The adsorbent material in one or more of the adsorption columns may be regenerated to produce a tail gas. At least a portion of the tail gas may be recycled to mix into the enhanced gas stream at a point upstream of the membrane unit.

According to another embodiment, a gas processing system is configured for performing any of the methods disclosed herein.

According to another embodiment, a gas processing system for producing a purified hydrogen gas stream comprises: a processing unit configured to increase a H₂ to CO ratio in a feed gas to produce an enhanced gas; a first separation unit configured to remove a substantial portion of N₂ gas from the enhanced gas to produce a denitrogenated gas; a second separation unit configured to remove a substantial portion of N₂, H₂O, CO₂ and CO gases to produce a purified H₂ gas stream, the second separation unit also producing a tail gas containing residual CO₂, N₂, H₂O, H₂ and CO; and a recycling system for routing at least a portion of of the tail gas to mix into the enhanced gas at a point upstream of the first separation unit.

According to another embodiment, a gas processing system for producing a purified hydrogen gas stream comprises: a processing unit configured to increase a H₂ to CO ratio in a feed gas to produce an enhanced gas; a separation unit configured to remove a substantial portion of N₂ and CO₂ to produce a purified H₂ gas stream, the second separation unit also producing a tail gas with any remaining impurities; and a recycling system for routing at least a portion of the tail gas to mix into the enhanced gas at a point upstream of the first separation unit.

While much of the disclosure focuses on N₂ and CO₂ removal processes. Another way to think of the disclosed process is that it separates a majority of the H₂ from the contaminants and then selectively removes any remaining impurities from the H₂. The benefit of the unique combination of these individual separation steps is that H₂ loss can be minimized to near zero by recycle of the tail gas stream.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is a schematic view of an example of a gas processing system in which hydrogen purification methods disclosed herein may be implemented according to some embodiments.

FIG. 2 is a schematic view of an example of a purification unit according to some embodiments.

FIG. 3 is an exemplary flowchart of a method for producing a purified hydrogen gas stream according to some embodiments.

FIG. 4 is an exemplary flowchart of a method for producing a purified hydrogen gas stream according to some embodiments.

FIG. 5 is an exemplary flowchart of a method for producing a purified hydrogen gas stream according to some embodiments.

### DETAILED DESCRIPTION

As used herein, the term “syngas” refers to synthesis gas. In the context of the present disclosure, syngas is a mixture of at least carbon monoxide (CO) and diatomic hydrogen gas (H₂). Depending on the embodiment, syngas may additionally include other components such as, for example, water, air, diatomic nitrogen gas (N₂), diatomic oxygen gas (O₂), carbon dioxide (CO₂), sulfur compounds (e.g., hydrogen sulfide (H₂S), carbonyl sulfide (COS), sulfur oxides (SOₓ), etc.), nitrogen compounds (e.g., nitrogen oxides (NOx), etc.), metal carbonyls, hydrocarbons (e.g., methane (CH₄)), ammonia (NH₃), chlorides (e.g., hydrogen chloride (HCl)), hydrogen cyanide (HCN), trace metals and metalloids (e.g., mercury (Hg), arsenic (As), selenium (Se), cadmium (Cd), etc.) and compounds thereof, particulate matter (PM), etc.

As used herein, the term “natural gas” refers to a mixture of hydrocarbon (HC) gases consisting primarily of methane and lesser amounts of higher alkanes. Depending on the embodiment, natural gas may additionally include non-HC species such as one or more of those noted above, as well as carbon disulfide (CS₂) and/or other disulfides, and mercaptans (thiols) such as methanethiol (CH₃SH) and ethanethiol (C₂H₅SH), thiophene, and other organosulfur compounds.

As used herein, the term “fluid” generally encompasses the term “liquid” as well as term “gas” unless indicated otherwise or the context dictates otherwise. The term “fluid” encompasses a fluid in which particles are suspended or carried. The term “gas” encompasses a gas that includes or entrains a vapor or liquid droplets. The term “fluid,” “liquid” or “gas” encompasses a “fluid,” “liquid” or “gas” that includes a single component (species) or a mixture of two or more different components. Examples of multicomponent mixtures include, but are not limited to, syngas and natural gas as described above.

As used herein, the term “process gas” generally refers to any gas initially containing H₂ and one or more contaminants. A process gas at an initial stage of a gas processing method as disclosed herein, i.e., when introduced into a gas processing system as disclosed herein, may also be referred to as a “raw gas” or a “feed gas.” A process gas after undergoing contaminant removal according to a gas processing method as disclosed herein may also be referred to as an “enhanced gas,” a “purified gas,” or a “permeate stream.” The term “process gas” generally is not limiting as to the composition of the gas at any particular stage of the gas processing method. For example, the term “process gas” does not by itself provide any indication of the concentrations of H₂ or any contaminants in the gas at any particular time. Examples of process gases include, but are not limited to, syngas and natural gas as described above. Further examples of process gases are gases that include one or more of: CO, CO₂, H₂, N₂, and hydrocarbon(s) (HCs).

As used herein “selectivity” of a gas separation membrane in separating a two-component gas mixture is defined as the ratio of the gas permeances of the two components in a gas mixture. Selectivity may be obtained directly by contacting a gas separation membrane with a known mixture of gases and analyzing the permeate. Alternatively, a first approximation of the selectivity is obtained by measuring permeance of the gases separately on the same gas separation membrane.

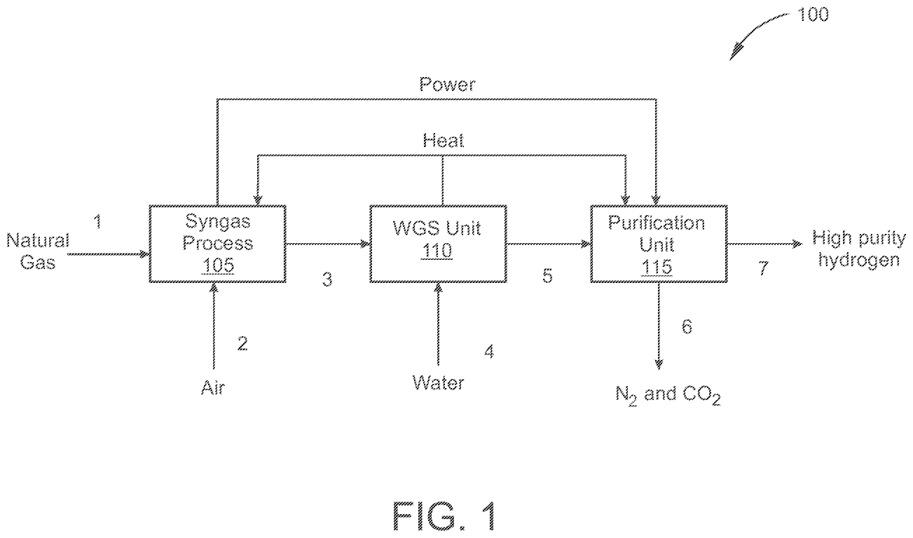

The present disclosure provides methods for purifying a syngas in which N₂ is the majority component (i.e., has the highest mole fraction of any component in the syngas) to produce a purified H₂ gas stream. In various embodiments as illustrated in FIG. 1, an exemplary gas processing system 100 may comprise a syngas reaction unit 105. In a non-limiting embodiment, the syngas reaction unit 105 may have a raw gas feed (indicated by stream 1 in FIG. 1) that serves as a fuel, and an oxidizer feed (stream 2) such as air, enriched air, and oxygen, in certain embodiments, the oxidant may also contain steam and/or CO₂. The raw gas feed (stream 1) may be, for example, a low-quality hydrocarbon stream from an industrial process or from a natural gas or crude oil production process. The fuel may also comprise natural gas containing primarily methane (CH₄). In certain embodiments, the fuel to the syngas reaction unit 105 may be coal, petroleum coke, biomass, or any other carbonaceous feedstock.

In certain embodiments, the syngas reaction unit 105 may comprise an internal combustion engine operated under fuel-rich conditions to partially oxidize the fuel (as opposed to operating the engine to completely combust the fuel) to produce syngas (stream 3) comprising N₂, H₂, CO, and various contaminants. The syngas (stream 3) may flow to a water-gas shift (WGS) unit 110 along with a water feed (stream 4) to produce an enhanced gas (stream 5) having a higher H₂ to CO ratio than the syngas (stream 3). The enhanced gas (stream 5) may flow to a purification unit 115 which may comprise one or more separation processes as discussed below to remove a portion of the contaminants from the enhanced gas (stream 5). The purification unit 115 may produce a high purity H₂ gas (stream 7) and a tail gas (stream 6) comprising N₂, CO₂, and other contaminants, as well as residual H₂.

In certain embodiments, the syngas reaction unit 105 may comprise a gasification unit operated to partially oxidize carbonaceous feedstocks to produce syngas (stream 3). In case of high-sulfur carbonaceous fuels used in syngas reaction unit 105, a desulfurization system operating at temperatures between 482 to 1292° F. (250 to 700° C.) as disclosed in the U.S. Pat. No. 6,951,635 is used prior to sending the syngas to the WGS unit to reduce the total sulfur concentration to less than 100 ppmv, preferably below 50 ppmv, and more preferably below 20 ppmv. Syngas from the desulfurization unit may flow to the water-gas shift (WGS) unit 110 along with a water feed (stream 4) to produce an enhanced gas (stream 5) having a higher H₂ to CO ratio than the syngas (stream 3). The enhanced gas (stream 5) may flow to a purification unit 115 which may comprise one or more separation processes as discussed below to remove a portion of the contaminants from the enhanced gas (stream 5). The purification unit 115 may produce a high purity H₂ gas (stream 7) and a tail gas (stream 6) comprising N₂, CO₂, and other contaminants, as well as residual H₂.

In certain embodiments, the syngas reaction unit 105 may comprise a partial oxidation system for which air is an oxidant operated to partially oxidize hydrocarbon feedstocks to produce syngas (stream 3). Syngas from the syngas reaction unit may flow to the water-gas-shift (WGS) unit 110 along with a water feed (stream 4) to produce an enhanced gas (stream 5) having a higher H₂ to CO ratio than the syngas (stream 3). The enhanced gas (stream 5) may flow to a purification unit 115 which may comprise one or more separation processes as discussed below to remove a portion of the contaminants from the enhanced gas (stream 5). The purification unit 115 may produce a high purity H₂ gas (stream 7) and a tail gas (stream 6) comprising N₂. CO₂, and other contaminants, as well as residual H₂.

In various embodiments, the syngas (stream 3) may have an initial H₂ to CO ratio of about 0.6 to about 3. In certain embodiments, the initial H₂ to CO ratio may range from about 1.5 to about 2.5. In certain embodiments, the second H₂ to CO ratio (i.e., the ratio in the enhanced gas (stream 5)) may range from about 8 to about 150. In certain embodiments, the second H₂ to CO ratio may range from about 8 to about 120. In certain embodiments, the second H₂ to CO ratio may range from about 8 to about 50.

For those embodiments utilizing an internal combustion engine as the syngas reaction unit 105, mechanical energy produced by the engine may be used to directly power or to operate a generator to produce electricity for a variety of equipment in the purification unit 115 such as pumps, compressors, controllers, etc. Alternatively, the power or electricity may be used for any other desired purpose. Additionally, in certain embodiments the WGS unit 110 may generate heat energy which may be utilized by other steps of the process 100. Although FIG. 1 may use an internal combustion engine with a fuel and oxidizer feed, such an arrangement is optional and various embodiments may use any source of syngas containing H₂ and CO. Likewise, any generation of power or heat within the process 100 and its subsequent use is optional.

The WGS reaction is utilized to shift a gas comprising the reactants of water and CO to the products of CO₂ and H₂ by reacting the CO with steam over a catalyst bed. WGS is an industrially important process utilized to increase the H₂ to CO ratio to meet the downstream process requirements of a particular application. For example, WGS finds applications in pre-combustion CO₂ capture where a fuel is partially oxidized, as discussed above for FIG. 1, to produce syngas predominantly consisting of CO and H₂. This syngas is shifted to maximize the H₂ and CO₂ concentrations, and CO₂ may be subsequently removed to produce high purity H₂. WGS also finds widespread applications in chemicals production where the H₂ to CO ratio needs to be adjusted as per the process requirements, such as methanol and Fischer-Tropsch applications.

WGS is a moderately exothermic reversible reaction and is expressed by:

$$CO + {H}_{2} O ↔ {CO}_{2} + {H}_{2} \qquad Δ {H}_{298}^{°} = - 41.09 \frac{kiloJoules}{mole} ( \frac{kJ}{m o l} )$$

where ΔH₂₉₈° is the enthalpy of reaction at 298 Kelvin (K).

The equilibrium constant of the reaction decreases with increasing temperature. The reaction is thermodynamically favored at low temperatures and kinetically favored at high temperatures. As there is no change in the volume from reactants to products, the reaction is not affected by pressure.

The equilibrium of this reaction shows significant temperature dependence and the equilibrium constant decreases with an increase in temperature, that is, higher carbon monoxide conversion is observed at lower temperatures. In order to take advantage of both the thermodynamics and kinetics of the reaction, the industrial scale WGS is conducted in multiple adiabatic stages with interstage cooling in-between the reactors.

The water gas shift process uses steam to shift CO to CO₂ and produces H₂ in the process. In addition to being a reactant, the steam also serves to move the equilibrium of the water gas shift forward to higher H₂, controlling the temperature rise from the exothermic water gas shift reaction, which if left unchecked could deactivate the catalyst. The steam is also required to prevent coking on the catalyst surface, which also deactivates the catalyst.

Traditionally, WGS is carried out using two reactors in series to carry out a high temperature shift (HTS) followed by a low temperature shift (LTS). Water is added to the syngas fed to the first reactor (WGS 1). The water may be in the form of steam. Alternatively, this water may be in the form of liquid water for which the thermal energy needed to generate steam is extracted from the sensible heat in the feed gas via direct mixing of the feed gas and liquid water via a spray nozzle or atomizer. The use of liquid water enables additional cooling of the feed gas to the desired temperature for the shift reaction in the first reactor and the consumption of water generated during cooling of the enhanced gas downstream of the water gas shift reactors. The syngas from the outlet of the first reactor (WGS 1) is cooled to the desired shift inlet temperature by using the excess heat to generate and/or raise the temperature of steam and the cooled syngas is fed to the second reactor (WGS 2).

No specific limitations are placed on the configuration of the shift reactors. Generally, each shift reactor may have any configuration suitable for carrying out the WGS reaction. For this purpose, each shift reactor generally may include a vessel having an inlet and an outlet, and a shift catalyst in the vessel. Depending on the type of shift catalyst utilized, each shift reactor may include a structural support for the shift catalyst.

In some embodiments, the first shift reactor (WGS 1) is configured or operated to carry out a high temperature shift (HTS) reaction, while the second shift reactor (WGS 2) is configured or operated to carry out a LTS reaction. In some embodiments, in an HTS reaction the inlet temperature of the gas fed to a shift reactor ranges, for example, from 570 to 700° F. (298 to 371° C.). In some embodiments, in a LTS reaction the inlet temperature of the gas fed to a shift reactor ranges, for example, from 400 to 550° F. (204° C. to 288° C.). Depending on the type of shift reaction performed in the respective shift reactors, the HTS and LTS reactors may contain different type of catalysts.

Generally, the shift catalyst may be provided and supported in any form suitable for carrying out the WGS reaction. For example, the shift catalyst may be provided as a fixed bed that is positioned in the shift reactor such that gases are able to flow through the catalyst bed. The composition of the shift catalyst may depend on the operating temperature of the shift reactor and the composition of the gas to be processed by the shift reactor.

For those embodiments utilizing an internal combustion engine as the syngas reaction unit 105, the syngas will contain a trace levels of unreacted oxygen. Typically, the presence of strong oxidizing agents like oxygen in the feed stream to a WGS unit will cause deactivation of the active metal oxidation state in the WGS catalyst. With the first WGS reactor (WGS 1) containing a HTS catalyst, the operating conditions and oxygen concentration are suitable for the catalytic conversion of any trace concentrations of oxygen present in the syngas feed from the engine operated to produce syngas into water with minimal adverse effect on catalyst activity. Therefore, in this embodiment, no separate oxygen removal system is needed.

Similarly, the standard iron-based HTS catalyst can tolerate up to 50 ppmv of sulfur compounds without any significant deactivation due to sulfur poisoning. Because of this, the trace quantifies of sulfur present in the feed natural gas for safety reasons (leak detection) will not impact the performance of the WGS process. Similarly, for the gasification embodiment using high sulfur carbonaceous feed and a desulfurization unit to reduce the sulfur concentration to less than 50 ppmv will enable use of a conventional HTS catalyst without any issue. These sulfur compounds will remain in the enhanced gas for ultimate removal in a more appropriate downstream separation process and no separate polishing sulfur removal is envisioned in this embodiment.

No specific limitations are placed on the type or configuration of the heat exchangers used in this the WGS process or purification processes. This means that any heat reduction system enabling control of the effluent syngas temperature to meet the temperature specification for the downstream process is satisfactory. Examples of potentially suitable heat exchangers are water cooled, air cooled, and/or other liquid coolants used with refrigeration cycles. Alternatively, the use of sensible heat of the feed gas to vaporize water and its cooling effect are particularly well suited for the WGS process enabling recycle of condensed water collected during cooling downstream of the WGS process while also providing steam for the WGS reaction.

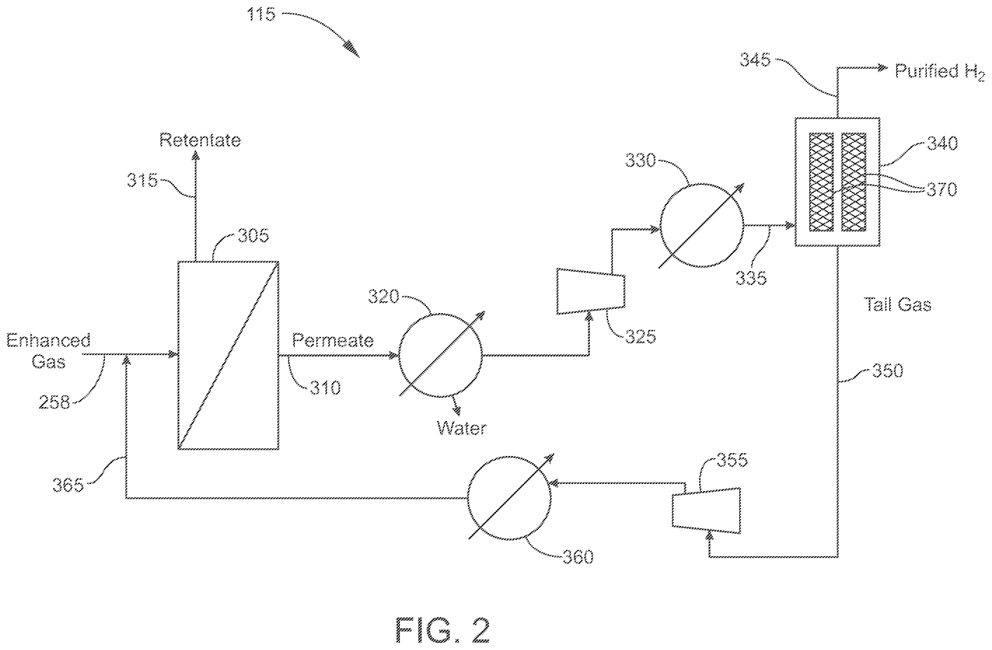

The output of the WGS system 110 (stream 5) may be the input to the purification unit 115. FIG. 2 illustrates an exemplary purification unit 115 according to various embodiments. The enhanced gas may flow to first separation unit 305. In certain embodiments, the first separation unit 305 may comprise a membrane unit. The membrane unit may comprise a dense membrane with a H₂ selective composition, allowing H₂ to preferentially flow through the membrane unit in the permeate stream 310, while certain contaminants, namely N₂ and CO₂, are removed in the retentate stream 315. The membrane may comprise a semi-permeable polymer (various membrane materials are known in the art, for example, but without limitation, such as a polyimide, polyamide, polyvinyl acetate, polysulfone, polytetrafluoroethylene (PFTE), cellulose acetate, other cellulose derivatives, polyether ether ketone, polybenzimidazole, polyolefins, etc.), a ceramic, a carbon compound, activated carbon, or a metallic compound. The H₂ selectivity, which is generally defined as the permeability of H₂ versus that of other gases in the mixture, of the membrane may range from 10 to 200, and the area of contact of the membrane may be determined from characteristics of the output stream 5 of the WGS system 110 and operating characteristics (e.g., temperature and pressure) of the membrane unit. In various embodiments, the membrane unit may operate at a temperature ranging from −4° F. to 480° F. (−20° C. to 250° C.) and a pressure ranging from 1 atm to 100 atm (101 kPa to 10,100 kPa). The membrane used for this purpose are preferably in the form of hollow fibers or flat sheets, and are modularized into spiral-wound design, plate and frame design, or hollow fiber design. For example, one such spiral-wound membrane is the commercially available cellulose acetate membrane modules supplied by UOP (Des Plaines, IL) for CO₂ separation from methane and one such hollow fiber membrane module is commercially supplied by Air Liquide (Houston, TX) for on-board nitrogen generation systems for N₂ separation from air.

Hydrogen permeation in dense membranes may occur through a solution-diffusion mechanism, wherein the gas molecules initially adsorb or dissolve onto the surface of the membrane material. Once adsorbed onto the membrane surface, the gas molecules may diffuse through the membrane material. In various embodiments, because the hydrogen selectivity of the membrane is much greater than the selectivity for each individual contaminant, very little of the contaminants (e.g., N₂, CO, CO₂, sulfur compounds) in the gas permeate through the membrane surface and such contaminants leave the membrane unit 305 in the retentate stream 315.

The permeate stream 310 may flow to a first heat exchanger 320 to remove water prior to increasing the pressure of the permeate stream 310 by compressor 325. Excess heat generated by the compression step may be removed by a second heat exchanger 330. The resulting pressurized stream 335 may flow to a second separation unit 340. The pressurized stream 335 may have a pressure ranging from 2 bar to 100 bar (200 kPa to 10,000 kPa) and a temperature ranging from 32° F. to 122° F. (0° C. to 50° C.). In certain embodiments, the second separation unit 340 may comprise a pressure swing adsorption (PSA) unit. PSA is based on one or more adsorbent beds 370 that capture contaminants in the pressurized stream 335 thereby allowing the H₂ to pass through the PSA unit, and then later releasing the adsorbed contaminants at a lower pressure (generally, lower than the pressure of the pressurized stream 335) when the adsorbent bed 370 is regenerated. This regenerate stream is the tail gas stream 350 in FIG. 2. Multiple adsorbent beds 370 may be utilized simultaneously so that a continuous stream of H₂ at purities greater than 99.9 percent may be produced. In a two-bed PSA process, the feed mixture contacts the first adsorbent bed containing adsorbents which preferentially adsorb certain components of the mixture. The less adsorbed component will break through the bed faster and produce a stream with high content of this component. The feed flow is switched to a second adsorbent bed before the other component(s) break through and the first bed is regenerated by desorbing the adsorbed compounds through the reduction of the total pressure of the system. The same process is repeated at the second adsorbent bed and for the complete PSA process. Other variations of PSA process with multiple beds operates under the same principle.

The adsorbent in PSA systems may be chosen for their ability to discriminate between different gases in a mixture. In certain embodiments, the adsorbent may be chosen to preferentially remove CO₂ from the pressurized stream 335. When multiple adsorbent beds 370 are used, the adsorbent in each adsorbent bed may be selected to preferentially remove one or more target contaminants. For example, one (or more) adsorbent beds 370 may target CO₂, while another adsorbent bed 370 targets H₂S, and yet another adsorbent bed 370 may target CO. The adsorbent works on the principle that gases under elevated pressures are attracted to a surface of a solid based on their affinity and may be captured or adsorbed onto that surface. Generally, the higher the pressure, the more gas that will be adsorbed. Once the pressure is reduced, the gas tends to desorb. Thus, an adsorbent bed 370 operating under pressure removes one or more contaminants from the pressurized stream 335, and the purified H₂ stream 345 flows out of the PSA unit 340. Once the adsorbent reaches its adsorption capacity, flow of the pressurized stream 335 to the adsorbent bed 370 is shut off and the pressure allowed to fall. As the pressure falls, the contaminants desorb from the surface of the adsorbent and flow out of the PSA unit 340 in the tail gas stream 350. The adsorbent may be any type known in the art, such as zeolites, activated carbon (including molecular sieves), alumina, silica gel, and resins.

In various embodiments, all or a portion of the tail gas stream 350 may be recycled to or upstream of the first separation unit 305 by combining the tail gas stream 350 with the enhanced gas stream 5 prior to flowing into the first separation unit 305. Although the adsorbent is selected to remove contaminants from the H₂ stream, some H₂ may be adsorbed and then discharged in the tail gas stream 350. Without recycling this stream, the H₂ in the tail gas 350 would be lost and overall recovery of H₂ by the process 100 may not be as good as with recycling of the tail gas 350. By recycling all of the tail gas 350, the process 100 may achieve a H₂ recovery rate of greater than 99 percent of the H₂ contained in the feed gas. Recycling less than 100 percent of the tail gas will reduce the H₂ recovery rate accordingly. For example, H₂ recovery of 75 percent or greater, 90 percent or greater, or 95 percent or greater may be achieved by varying the amount of tail gas recycled. In some embodiments, the amount of the tail gas recycled may range from about 50 percent to about 100 percent of the tail gas. If none of the tail gas 350 is recycled, then the H₂ recovery rate may be as low as 75 percent. In order to properly condition the tail gas 350 for recycling, the tail gas 350 may flow to a compressor 355 to increase pressure generally to that of the enhanced gas stream 5, and may then flow to a heat exchanger 360 to remove excess heat caused by compression. The conditioned tail gas 365 may then be mixed into the enhanced gas stream 5. In certain embodiments, the pressure of the recycled tail gas 350 may range from about 1 atm to about 10 atm (about 100 kPa to about 1,000 kPa) and matches that of stream 5.

In various embodiments, the recycled tail gas stream 350 may range from about 5 percent to about 10 percent by volume of the purified H₂ stream 345, and may range from about 15 percent to about 25 percent by volume of the enhanced gas stream 5. Thus, extremely high H₂ recovery rates (i.e., greater than 99 percent) may be achieved by a relatively small recycle stream. Table 1 presents the results of a material balance for the process illustrated in FIGS. 1 through 2, demonstrating production of a high purity H₂ stream containing 99.97 percent H₂.

TABLE 1
Material Balance for Overall Process (stream numbering corresponds to FIG. 1)

| | Stream | | | | | | |
|---|---|---|---|---|---|---|---|
| | 1 | 2 | | | 5 | 6 | 7 |
| Mole | Natural | Oxidizer | 3 | 4 | Enhanced | Tail | High |
| Fraction | Gas | (Air) | Syngas | Water | Gas | Gas | Purity H₂ |
| H₂ | | | 0.194 | | 0.3035 | 0.003 | 0.9997 |
| CO | | | 0.126 | | 0.021 | 0.031 | |
| CO₂ | 0.02 | | 0.025 | | 0.132 | 0.19 | |
| CH₄ | 0.98 | | 0.011 | | 0.011 | 0.016 | |
| H₂O | | 0.023 | 0.130 | 1.0 | 0.014 | | |
| N₂ | | 0.771 | 0.511 | | 0.518 | 0.76 | 0.0003 |
| O₂ | | 0.205 | 0.002 | | | | |
| Molar Flow | 3.4 | 13.9 | 20.8 | 1.0 | 20.4 | 13.9 | 6.15 |
| (kgmole/hr) | | | | | | | |
| Mass Flow | 1351.3 | 9528.3 | 10963.2 | 432 | 10722.6 | 10306.0 | 295.1 |
| (kg/day) | | | | | | | |

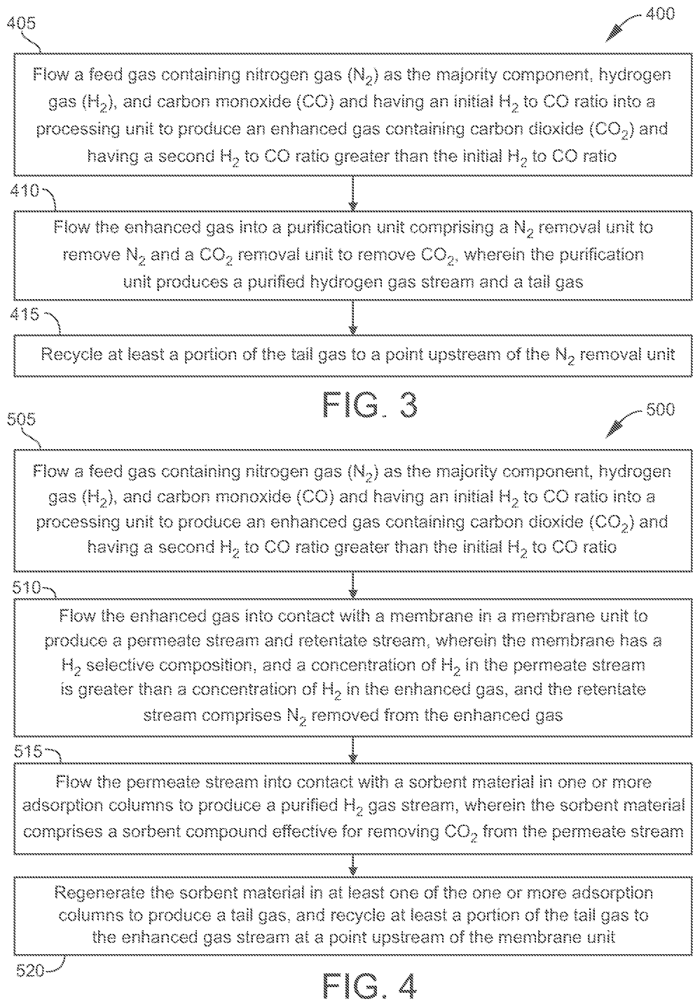

FIG. 3 illustrates a general flow diagram of various embodiments of a method 400 for producing a purified hydrogen gas stream. At step 405, a feed gas containing N₂ as the majority component, H₂, and CO may flow into a processing unit 110 to produce an enhanced gas 5. The feed gas may have an initial H₂ to CO ratio, and the enhanced gas 5 may contain CO₂ and may have a second H₂ to CO ratio greater than the initial H₂ to CO ratio. The enhanced gas 5 may flow into a purification unit 115 at step 410. The purification unit 115 is designed to produce high purity H₂ and may comprise a unit 305 to produce a stream 310 largely depleted of N₂, CO₂ and other non-H₂ gases and a unit 340 to produce a purified H₂ stream. The purification unit 115 may produce a purified H₂ gas stream 345 and a tail gas 350. At step 415, at least a portion of the tail gas 350 may be recycled to a point upstream of the N₂ removal unit 305.

FIG. 4 illustrates another general flow diagram a method 500 for producing a purified hydrogen gas stream according to various embodiments. At step 505, a feed gas containing N₂ as the majority component, H₂, and CO may flow into a processing unit 110 to produce an enhanced gas 5. The feed gas may have an initial H₂ to CO ratio, and may have a second H₂ to CO ratio greater than the initial H₂ to CO ratio. The enhanced gas 5 may flow into contact with a membrane in a membrane unit 305 to produce a permeate stream 310 and a retentate stream 315 at step 510. The membrane may have a H₂ selective composition. A concentration of H₂ in the permeate stream 310 may be greater than a concentration of H₂ in the enhanced gas 5, and the retentate stream 315 may comprise N₂ and other contaminants that are removed from the enhanced gas 5. At step 515, the permeate stream 310 may flow into contact with an adsorbent material in one or more adsorption columns 370 to produce a purified H₂ gas stream 345. The adsorbent material may comprise a sorbent compound effective for removing N₂ or H₂O or CO or CO₂ from the permeate stream 310. At step 520, the adsorbent material in one or more of the adsorption columns 370 may be regenerated to produce a tail gas 350. At least a portion of the tail gas 350 may be recycled to the enhanced gas stream 5 at a point upstream of the membrane unit 305.

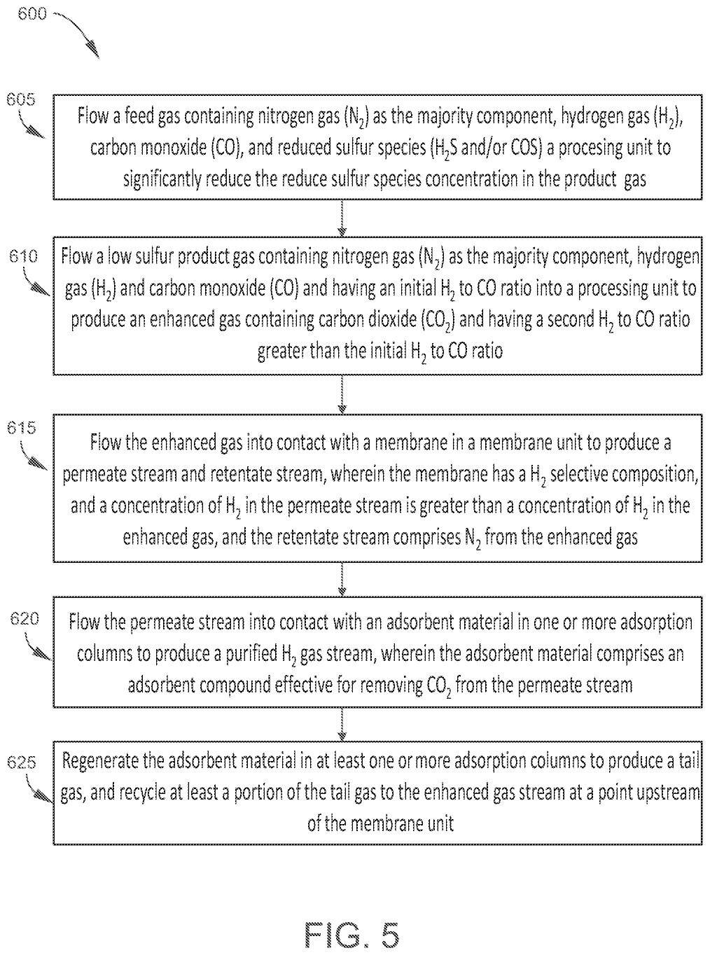

FIG. 5 illustrates another general flow diagram a method 600 for producing a purified hydrogen gas stream according to various embodiments. At step 605, a feed gas containing N₂ as the majority component, H₂, and CO and reduced sulfur species including H₂S and COS may flow into a processing unit to remove this sulfur and to produce a product gas with low sulfur (<50 ppmv). At step 610, this product gas may flow into a processing unit 110 to produce an enhanced gas 5. The product gas flowing into processing unit 110 may have an initial H₂ to CO ratio, and may have a second H₂ to CO ratio greater than the initial H₂ to CO ratio. The enhanced gas 5 may flow into contact with a membrane in a membrane unit 305 to produce a permeate stream 310 and a retentate stream 315 at step 615. The membrane may have a H₂ selective composition. A concentration of H₂ in the permeate stream 310 may be greater than a concentration of H₂ in the enhanced gas 5, and the retentate stream 315 may comprise N₂ and other contaminants that are removed from the enhanced gas 5. At step 620, the permeate stream 310 may flow into contact with an adsorbent material in one or more adsorption columns 370 to produce a purified H₂ gas stream 345. The adsorbent material may comprise a sorbent compound effective for removing N₂ or H₂O or CO or CO₂ from the permeate stream 310. At step 625, the adsorbent material in one or more of the adsorption columns 370 may be regenerated to produce a tail gas 350. At least a portion of the tail gas 350 may be recycled to the enhanced gas stream 5 at a point upstream of the membrane unit 305.

### Example

Aspen HYSYS® (Aspen Technology, Inc., Bedford, MA) process models were developed for the H₂ purification process illustrated in FIG. 2. The syngas (feed) was assumed to be that produced by partial oxidation of methane and air. Table 2 presents the results of a material balance on the purification process as calculated by the HYSYS model.

TABLE 2
Modeled Material Balance for the Purification Process.

| | Unit | Feed | Retentate | Permeate | PSA Inlet | Water | Recycle | Product |
|---|---|---|---|---|---|---|---|---|
| Temperature | ° C. | 30 | 29 | 30 | 35 | 35 | 33 | 34 |
| Pressure | kPa | 300 | 270 | 100 | 970 | 970 | 100 | 900 |
| Molar Flow | kg/mole/hr | 20.4 | 14.0 | 11.8 | 11.6 | 0.3 | 5.5 | 6.1 |
| Mass Flow | kg/hr | 447.1 | 430.0 | 155.8 | 150.8 | 5.0 | 138.5 | 12.3 |

Mole Fraction

| | | | | | | | | |
|---|---|---|---|---|---|---|---|---|
| CO₂ | | 0.1322 | 0.1931 | 0.2189 | 0.2241 | 0.0008 | 0.4741 | 0.0000 |
| H₂O | | 0.0141 | 0.0000 | 0.0294 | 0.0062 | 0.9992 | 0.0131 | 0.0000 |
| CH₄ | | 0.0111 | 0.0162 | 0.0003 | 0.0003 | 0.0000 | 0.0006 | 0.0000 |
| N₂ + Ar | | 0.5181 | 0.7537 | 0.0528 | 0.0540 | 0.0000 | 0.1139 | 0.0003 |
| O₂ | | 0.0000 | 0.0000 | 0.0000 | 0.0000 | 0.0000 | 0.0000 | 0.0000 |
| H₂ | | 0.3035 | 0.0067 | 0.6948 | 0.7114 | 0.0000 | 0.3898 | 0.9997 |
| CO | | 0.0209 | 0.0304 | 0.0039 | 0.0040 | 0.0000 | 0.0085 | 0.0000 |
| Membrane | | 58.2% | | | | | | |
| Stage Cut | | | | | | | | |
| H₂ Flow | kg/day | 296.6 | 4.5 | 395.0 | 395.0 | 0.0 | 102.3 | 292.7 |
| MW | | 21.9 | 30.7 | 13.1 | 13.0 | 18.0 | 25.3 | 2.0 |
| Volumetric | scfm | 268.7 | 184.7 | 156.4 | 152.7 | 3.7 | 72.2 | 80.5 |
| Flow | | | | | | | | |

The above Example is for illustrative purposes only and does not restrict the invention to the processes used in the example.

In general, terms such as “communicate” and “in . . . communication with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate with a second component is not intended to exclude the possibility that additional components may be present between, and/or operatively associated or engaged with, the first and second components.

It will be understood that various aspects or details of the invention may be changed without departing from the scope of the invention. Furthermore, the foregoing description is for the purpose of illustration only, and not for the purpose of limitation—the invention being defined by the claims.

What is claimed is:

1. A gas processing system for producing a purified hydrogen gas stream, the gas processing system comprising:
a processing unit configured to increase a hydrogen (H₂) to carbon monoxide (CO) ratio in a feed gas to produce an enhanced gas;
a first separation unit configured to remove a substantial portion of nitrogen gas (N₂) from the enhanced gas to produce a denitrogenated gas;
a second separation unit configured to remove a substantial portion of carbon dioxide (CO₂) from the denitrogenated gas to produce a purified H₂ gas stream, the second separation unit also producing a tail gas containing the removed CO₂; and
a recycling system for routing at least a portion of the tail gas to the enhanced gas at a point upstream of the first separation unit.

2. The gas processing system of claim 1, wherein the processing unit comprises a water-gas shift unit, and configured to shift the feed gas to produce H₂ and CO₂.

3. The gas processing system of claim 1, wherein the first separation unit comprises a H₂ selective membrane.

4. The gas processing system of claim 1, wherein the second separation unit comprises a pressure swing adsorption (PSA) unit.

5. The gas processing system of claim 4, wherein the PSA unit comprises a sorbent compound effective for removing CO₂ from the denitrogenated gas.

6. The gas processing system of claim 1, wherein the recycling system is configured to recycle up to and including 100 percent of the tail gas.

7. The gas processing system of claim 1, wherein the gas processing system is configured to produce the purified H₂ gas stream with a mole fraction of H₂ greater than about 99 percent.

8. The gas processing system of claim 1, wherein the gas processing system is configured to recover an amount of H₂ present in the enhanced gas and recovered in the purified H₂ gas stream selected from the group consisting of: greater than about 80 percent; greater than about 90 percent; greater than about 95 percent; and greater than about 99 percent.
